(19) United States
(12) Patent Application Publication
(10) Pub. No.: US 2016/0322857 A1
(43) Pub. Date: Nov. 3, 2016

(54) COIL, NON-CONTACT POWER RECEIVING APPARATUS, AND PORTABLE ELECTRONIC DEVICE

(71) Applicant: TDK Corporation, Tokyo (JP)

(72) Inventors: Kazuya Itagaki, Tokyo (JP); Shinji Higuma, Tokyo (JP)

(21) Appl. No.: 15/141,883

(22) Filed: Apr. 29, 2016

(30) Foreign Application Priority Data
Apr. 30, 2015 (JP) 2015-092624

(51) Int. Cl. H02J 7/02; H01F 27/24; H02J 50/10; H01F 27/29; H01F 27/28; H01F 27/02

(52) U.S. Cl. CPC H02J 7/025; H01F 27/2804; H01F 27/02; H02J 50/10; H01F 27/29; H01F 27/24; H01F 2027/2809

(57) ABSTRACT

A first flexible board includes first electrodes and first conductors. Each of the first conductors bridges and electrically connects one of the first electrodes on one side of the first board to one of the first electrodes on the other side of the first board. A second flexible board has second electrodes and second conductors. Each of the second conductors bridges and electrically connects one of the second electrodes on one side of the second board and one of the second electrodes on the other side of the second board. The first flexible board and the second flexible board are laminated to each other such that the first electrodes and the second electrodes are in face-to-face contact with each other, and the first conductors and the second conductors form a current path helically encircling an axis in a direction extending through the first electrodes and the second electrodes.

### BACKGROUND OF THE INVENTION

1. Field of the Invention

The present invention relates to a coil used for, for example, non-contact power receiving, and a non-contact power receiving apparatus including the coil, as well as a portable electronic device having a non-contact power receiving function.

2. Description of the Related Art

Portable electronic devices including wearable devices such as earphones, headsets, and hearing aids are recently further reduced in size and rechargeable batteries are increasingly used as power sources thereof When a rechargeable battery is used as a power source, a method of charging may include inserting a connector of a charging cable into a portable electronic device and an operation of inserting the connector is troublesome. If a connector plug is formed in a simple structure for inserting, it becomes difficult to make the connector waterproof In this regard, charging using non-contact power receiving eliminates the troublesome operation of inserting a connector into a portable electronic device and makes it easy to achieve a waterproof structure. To give a non-contact power receiving function to a portable electronic device, a coil is necessary.

Patent Document 1: Japanese Laid-Open Patent Publication No. 2004-111831

Patent Document 2: Japanese Laid-Open Patent Publication No. 2006-38712

As described above, it is highly advantageous to give a non-contact power receiving function to portable electronic devices; however, as the portable electronic devices are increasingly reduced in size, almost no space is actually left for newly disposing a coil for non-contact power receiving in a housing. Therefore, a thin coil is currently required that is mountable despite the restriction on disposition. Additionally, easiness of manufacturing is also required in terms of costs.

### SUMMARY OF THE INVENTION

The present invention was conceived in view of the situations and it is therefore an object of the present invention to provide a coil that can be thinned and easily manufactured, as well as a non-contact power receiving apparatus and a portable electronic device including the coil.

An aspect of the present invention is a coil. The coil comprises:
a first flexible board having a plurality of first electrodes and a plurality of first conductors; and
a second flexible board having a plurality of second electrodes and a plurality of second conductors,
the first and second flexible boards being combined with each other such that the pluralities of the first and second electrodes are brought into face-to-face contact with each other,
the pluralities of the first and second conductors forming a current path helically encircling an axis in a direction substantially parallel with surfaces of the first and second flexible boards through the pluralities of the first and second electrodes.

In the coil, the plurality of the first electrodes may be disposed such that pluralities of electrodes are separately located on one and the other sides opposite to each other on the first flexible board, wherein

each of the first conductors electrically connects one of the first electrodes on the one side and one of the first electrodes on the other side with each other, and
the plurality of second electrodes may be disposed such that pluralities of electrodes are separately located on one and the other sides opposite to each other on the second flexible board, and wherein
   each of the second conductors electrically connects one of the second electrodes on the one side and one of the second electrodes on the other side with each other.

The coil may comprise a soft magnetic body inserted to penetrate between the first and second conductors.

In the coil, the soft magnetic body may be longer than an axial length of the helically encircling current path.

In the coil, the second flexible board may have an extension portion extending on the outer side than the first flexible board, and the extension portion is provided with a circuit.

The coil may be flexible.

The coil may be disposed in a bent state inside a housing.

Another aspect of the present invention is a coil. The coil comprises: a flexible board having pluralities of electrodes respectively disposed in the vicinities of two sides opposite to each other and a plurality of conductors respectively electrically connecting the plurality of electrodes on one side and the plurality of electrodes on the other side,
the flexible board being bent to bring the plurality of electrodes on one side and the plurality of electrodes on the other side into face-to-face contact with each other,
the plurality of conductors forming a current path helically encircling an axis in a direction substantially parallel with a surface of the flexible board.

Other aspect of the present invention is a non-contact power receiving apparatus. The non-contact power receiving apparatus comprises a coil for non-contact power receiving, wherein
the coil is a flexible coil including
a first flexible board having a plurality of first electrodes and a plurality of first conductors, and
a second flexible board having a plurality of second electrodes and a plurality of second conductors,
the first and second flexible boards being combined with each other such that the first and second electrodes are brought into face-to-face contact with each other,
the pluralities of the first and second conductors forming a current path helically encircling an axis in a direction substantially parallel with surfaces of the first and second flexible boards through the pluralities of the first and second electrodes, and wherein the coil is disposed within a housing.

In the non-contact power receiving apparatus, the coil may be disposed in a bent state inside the housing.

In the non-contact power receiving apparatus, the second flexible board may have an extension portion extending on the outer side than the first flexible board, and the extension portion is provided with a control circuit for non-contact power receiving.

Other aspect of the present invention is a portable electronic device. The portable electronic device comprises: a rechargeable battery and a coil for non-contact power receiving, wherein
the coil is a flexible coil including
a first flexible board having a plurality of first electrodes and a plurality of first conductors, and
a second flexible board having a plurality of second electrodes and a plurality of second conductors,
the first and second flexible boards being combined with each other such that the first and second electrodes are brought into face-to-face contact with each other,
the pluralities of the first and second conductors forming a current path helically encircling an axis in a direction substantially parallel with surfaces of the first and second flexible boards through the pluralities of the first and second electrodes, and wherein the coil is disposed within a housing.

In the portable electronic device, the coil may be disposed in a bent state inside the housing.

In the portable electronic device, the second flexible board may have an extension portion extending on the outer side than the first flexible board, and the extension portion may be provided with at least a part of a power source circuit that is fed an output voltage of the rechargeable battery.

In the portable electronic device, the coil is used also as a part of the power source circuit.

The portable electronic device may switch whether the coil is connected to a control circuit for non-contact power receiving or connected to be a part of the power source circuit, between during charging and during use of the portable electronic device.

In the portable electronic device, the coil may be provided with a intermediate tap, and a coil portion on one side of the intermediate tap may be used as a part of the power source circuit.

It is to be noted that any arbitrary combination of the above-described structural components as well as the expressions according to the present invention changed among a system and so forth are all effective as and encompassed by the present aspect.

According to the aspects described above, it is possible to provide a coil that can be thinned and easily manufactured, as well as a non-contact power receiving apparatus and a portable electronic device including the coil.

### BRIEF DESCRIPTION OF THE DRAWINGS

FIG. 1 is a plan view of a coil 30 according to a first embodiment of the present invention.

FIG. 2 is a development plan view of a first flexible board 10 of the coil 30 of FIG. 1 turned over to the left and developed.

FIG. 3 is an enlarged cross-sectional view taken along A-A of FIG. 1.

FIG. 4 is a development cross-sectional view of the first flexible board 10 of FIG. 3 turned over to the left and developed.

FIG. 5 is a plan view of a coil 40 according to a second embodiment of the present invention.

FIG. 6 is an enlarged cross-sectional view taken along D-D of FIG. 5.

FIG. 7 is perspective view of a main portion of a coil 50 according to a third embodiment of the present invention.

FIG. 8 is a development plan view of a coil 60 according to a fourth embodiment of the present invention.

FIG. 9 is an enlarged cross-sectional view of a flexible board 61 of the coil 60 in the vicinity of a bent portion.

FIG. 10 is a schematic plan view of a non-contact power receiving apparatus 70 according to a fifth embodiment of the present invention.

FIG. 11 is a perspective view of the coil 50 in a developed state in the non-contact power receiving apparatus 70.

FIG. 12 is a perspective view of the coil 50 of FIG. 11 in a disassembled state.

FIG. 13 is a perspective view of a portable electronic device 80 according to a sixth embodiment of the present invention depicted along with a non-contact charger 90.

FIG. 14 is a cross-sectional view of a main portion of the portable electronic device 80 placed on the non-contact charger 90.

FIG. 15 is a circuit diagram of the portable electronic device 80 during use.

FIG. 16 is a circuit diagram of the portable electronic device 80 during charging.

### DESCRIPTION OF THE PREFERRED EMBODIMENTS

Now, preferred embodiments of the present invention will be described in detail, referring to the drawings. The same or equivalent constituent elements, members and so on which are shown in the respective drawings are denoted with the same reference numerals, and overlapped descriptions are appropriately omitted. Moreover, the present invention is not limited to the embodiments, but the embodiments are only examples. All features and the combinations of the features which are described in the embodiments are not absolutely essential to the present invention.

### First Embodiment

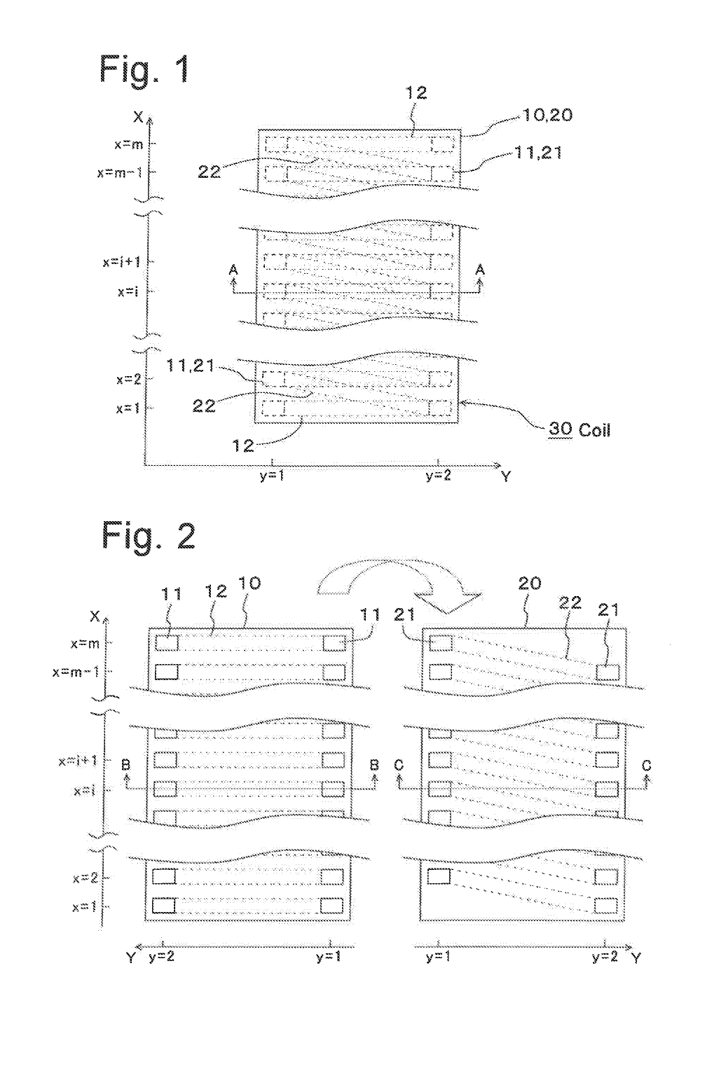

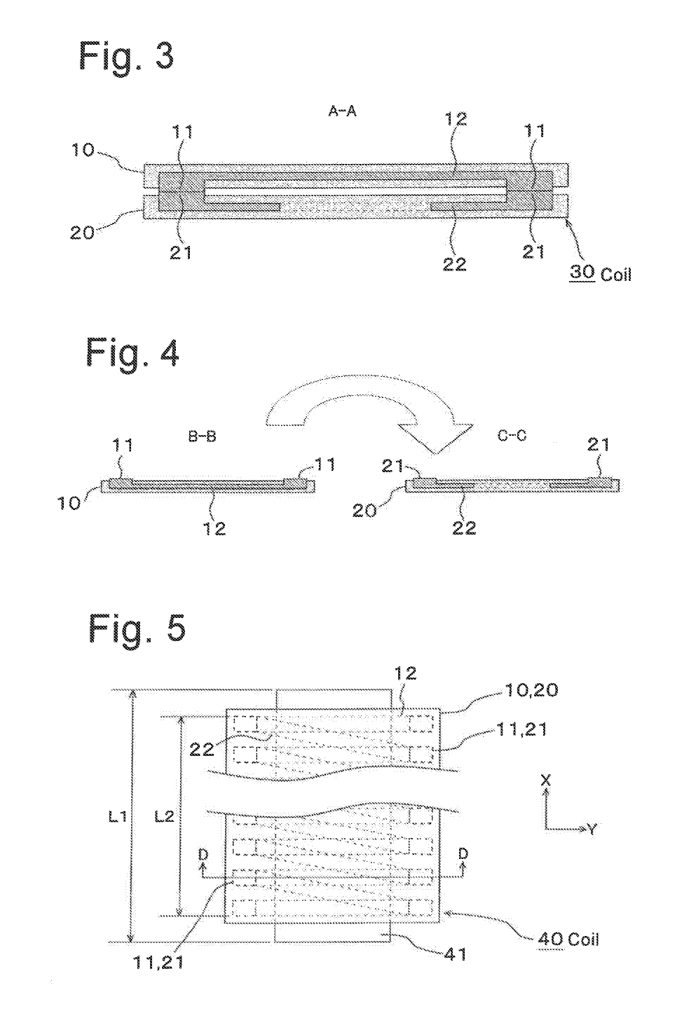

FIG. 1 is a plan view of a coil 30 according to a first embodiment of the present invention. FIG. 2 is a development plan view of a first flexible board 10 of the coil 30 of FIG. 1 turned over to the left and developed. FIG. 3 is an enlarged cross-sectional view taken along A-A of FIG. 1. FIG. 4 is a development cross-sectional view of the first flexible board 10 of FIG. 3 turned over to the left and developed. FIG. 1 defines an X axis and a Y axis orthogonal to each other as well as an X-Y rectangular coordinate system. The coil 30 includes a first flexible board 10 and a second flexible board 20.

The first flexible board 10 as a substrate has a plurality of first electrodes 11 made of a metal material such as copper and a plurality of first conductors 12 made of a metal material such as copper. The plurality of the first electrodes 11 is disposed such that pluralities of electrodes are separately located on one and the other sides facing (opposite to) each other on the first flexible board 10. Each of the first conductors 12 bridges and electrically connects one of the first electrodes 11 on one side and one of the first electrodes 11 on the other side with each other. In the shown example, the first conductors 12 extend in parallel with the Y direction to electrically connect the first electrodes 11 to each other at equal X-direction positions. Preferably, the first conductors 12 are disposed on a wiring layer inside the first flexible board 10 as shown in FIGS. 3 and 4.

The second flexible board 20 as a substrate has a plurality of second electrodes 21 made of a metal material such as copper and a plurality of second conductors 22 made of a metal material such as copper. The plurality of the second electrodes 21 is disposed such that pluralities of electrodes are separately located on one and the other sides facing (opposite to) each other on the second flexible board 20. Each of the second conductors 22 bridges and electrically connects one of the second electrodes 21 on one side and one of the second electrodes 21 on the other side with each other. In the shown example, the second conductors 22 extend obliquely at a predetermined angle relative to the Y direction to electrically connect the second electrodes 21 to each other at X-direction positions shifted by one electrode from each other. Preferably, the second conductors 22 are disposed on a wiring layer inside the second flexible board 20 as shown in FIGS. 3 and 4.

As shown in FIG. 3, the first flexible board 10 and the second flexible board 20 are combined (overlapped) with each other such that the first electrodes 11 and the second electrodes 21 are brought into face-to-face contact with each other. While being in face-to-face contact, the first electrodes 11 and the second electrodes 21 are electrically and mechanically connected to each other by pressure-bonding, soldering, etc. A mutual adhesion force (mechanical connection force) between the first electrodes 11 and the second electrodes 21 maintains the first flexible board 10 and the second flexible board 20 in a laminated state. In the laminated state shown in FIGS. 1 and 3, the first conductors 12 and the second conductors 22 form a current path (coil body portion) helically encircling an axis in the X direction through the first electrodes 11 and the second electrodes 21. The coil 30 can have various shapes from a sheet shape having a thickness within 1 mm, for example, to a stick shape having a width of about 2 mm.

The electrode arrangement and the electrode interconnection through conductors (conductive pattern) in the coil 30 will hereinafter specifically be described with the coordinate system shown in FIGS. 1 and 2. As shown in FIGS. 1 and 2, the length direction and the width direction of the first flexible board 10 and the second flexible board 20 are defined as the X direction and the Y direction, respectively.

The first electrodes 11 are arranged in the vicinities of two long sides facing each other on the first flexible board 10, i.e., at positions of y=1, 2, such that m electrodes are located along each of the long sides (in the x direction) of the first flexible board 10. Similarly, the second electrodes 21 are arranged in the vicinities of two long sides facing each other on the second flexible board 20, i.e., at positions of y=1, 2, such that m−1 electrodes are located along each of the long sides (in the x direction) of the second flexible board 20. The first electrodes 11 and the second electrodes 21 are located at x-coordinates defined as x=1 to x=m in order from the lower sides of FIGS. 1 and 2. On the second flexible board 20, the second electrode 21 may be added to one or both of the positions of (x,y)=(1,1), (m,2). On the first flexible board 10, the first electrode 11 may be eliminated at one or both of the positions of (x,y)=(1,1), (m,2).

When i is an arbitrary natural number equal to or less than m, the first electrode 11 located at the position of (x,y)=(i, 1) is electrically connected by the first conductor 12 to the first electrode 11 located at the position of (x,y)=(i,2). The second electrode 21 located at the position of (x,y)=(i+1,1) is electrically connected by the second conductor 22 to the second electrode 21 located at the position of (x,y)=(i,2). Such connection forms the current path (coil body portion) helically encircling the axis in the X direction.

According to this embodiment, the first flexible board 10 and the second flexible board 20 are overlapped to bring the first electrodes 11 and the second electrodes 21 into face-to-face contact so as to make up a coil such that the first conductors 12 and the second conductors 22 helically circle around through the first electrodes 11 and the second electrode 21 and, therefore, the coil can be thinned and is easily manufactured and excellent in mass productivity.

### Second Embodiment

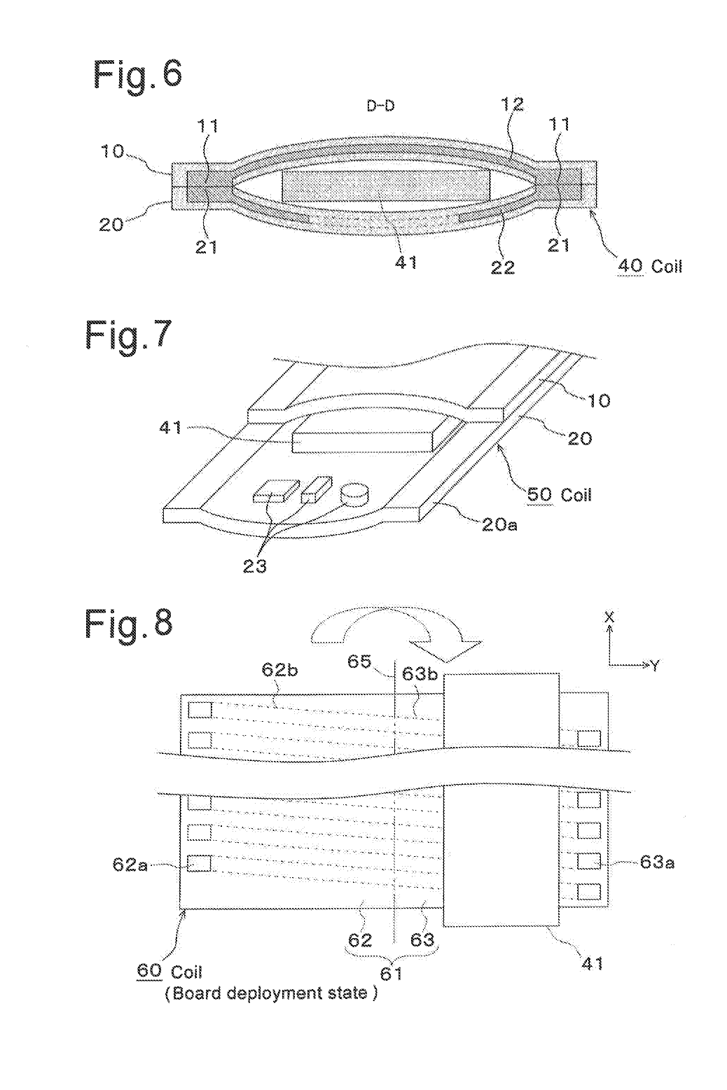

FIG. 5 is a plan view of a coil 40 according to a second embodiment of the present invention. FIG. 6 is an enlarged cross-sectional view taken along D-D of FIG. 5. The coil 40 of this embodiment is identical to the first embodiment except that a flexible thin plate-shaped soft magnetic body 41 is disposed (inserted) between the first flexible board 10 and the second flexible board 20. As shown in FIG. 6, the first flexible board 10 and the second flexible board 20 are warped to widen in the up-down direction so as to insert the soft magnetic body 41. As shown in FIG. 5, a length L1 of the soft magnetic body 41 is longer than a length L2 in the X axis direction of the helically encircling current path (coil body portion) of the coil 40. According to this embodiment, since the soft magnetic body 41 penetrates between the first conductors 12 and the second conductors 22, a higher inductance can be acquired from the same number of turns as compared to the first embodiment. Since the soft magnetic body 41 protrudes from the coil body portion on the both sides, if the coil 40 is used for non-contact power receiving, a magnetic force from a power-transmitting coil can efficiently be received with protruding portions of the soft magnetic body 41.

### Third Embodiment

FIG. 7 is perspective view of a main portion of a coil 50 according to a third embodiment of the present invention. The coil 50 of this embodiment is identical to the second embodiment except that the second flexible board 20 has an extension portion 20a extending in the length direction on the outer side than the first flexible board 10 and that the extension portion 20a is equipped with electronic components 23 and disposed with a conductive pattern not shown (i.e., the extension portion 20a is provided with a circuit). The circuit may be, for example, a control circuit of the non-contact power receiving, or a power source circuit such as a DC-DC converter, or a circuit encompassing both of these circuits. The coil 50 of this embodiment is a coil unit unitized with the circuit disposed on the extension portion 20a of the second flexible board 20, is advantageous for space-saving as compared to the case of disposing the circuit on another board, and is highly reliable because of reduced risks of disconnection etc. since connection to the other boards is unnecessary.

### Fourth Embodiment

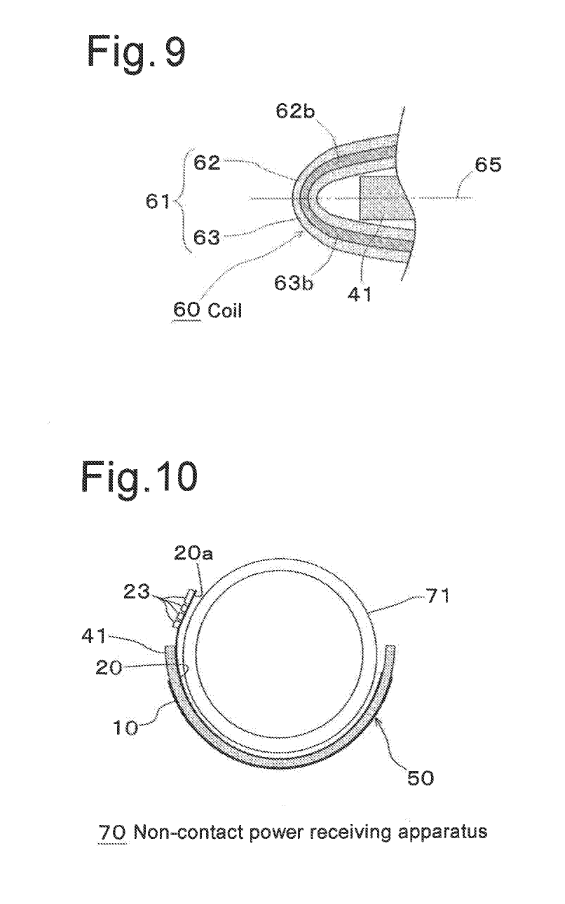

FIG. 8 is a development plan view of a coil 60 according to a fourth embodiment of the present invention. FIG. 9 is an enlarged cross-sectional view of a flexible board 61 of the coil 60 in the vicinity of a bent portion. The coil 60 of this embodiment is different from the second embodiment in that the first flexible board 10 and the second flexible board 20 are replaced with the one flexible board 61. In the flexible board 61, a left portion from a boundary line 65 at the center in the width direction is a first flexible board 62, and a right portion from the boundary line 65 is a second flexible board 63. The first flexible board 62 is disposed with a plurality of first electrodes 62a made of a metal material such as copper and a plurality of first conductors 62b made of a metal material such as copper. The second flexible board 63 is disposed with a plurality of second electrodes 63a made of a metal material such as copper and a plurality of second conductors 63b made of a metal material such as copper. The first conductors 62b and the second conductors 63b are connected (continuous) to each other at the boundary line 65. The first conductors 62b and the second conductors 63b extend obliquely at a predetermined angle relative to the Y direction to electrically connect the first electrodes 62a and the second electrodes 63a to each other at X-direction positions shifted by one electrode from each other. Preferably, the first conductors 62b and the second conductors 63b are disposed on a wiring layer inside the flexible board 61 as shown in FIG. 9. While the flexible board 61 is bent as shown in FIG. 9, the first electrodes 62a and the second electrodes 63a at the X-direction positions equal to each other are brought into face-to-face contact with each other. The first electrodes 62a and the second electrodes 63a are electrically connected to each other by pressure-bonding etc. as is the case with the first embodiment. A mutual adhesion force between the first electrodes 62a and the second electrodes 63a maintains the flexible board 61 in a bent state. The first conductors 62b and the second conductors 63b form a current path helically encircling an axis in the X direction through the first electrodes 62a and the second electrodes 63a. This embodiment can produce the same effect as the second embodiment.

### Fifth Embodiment

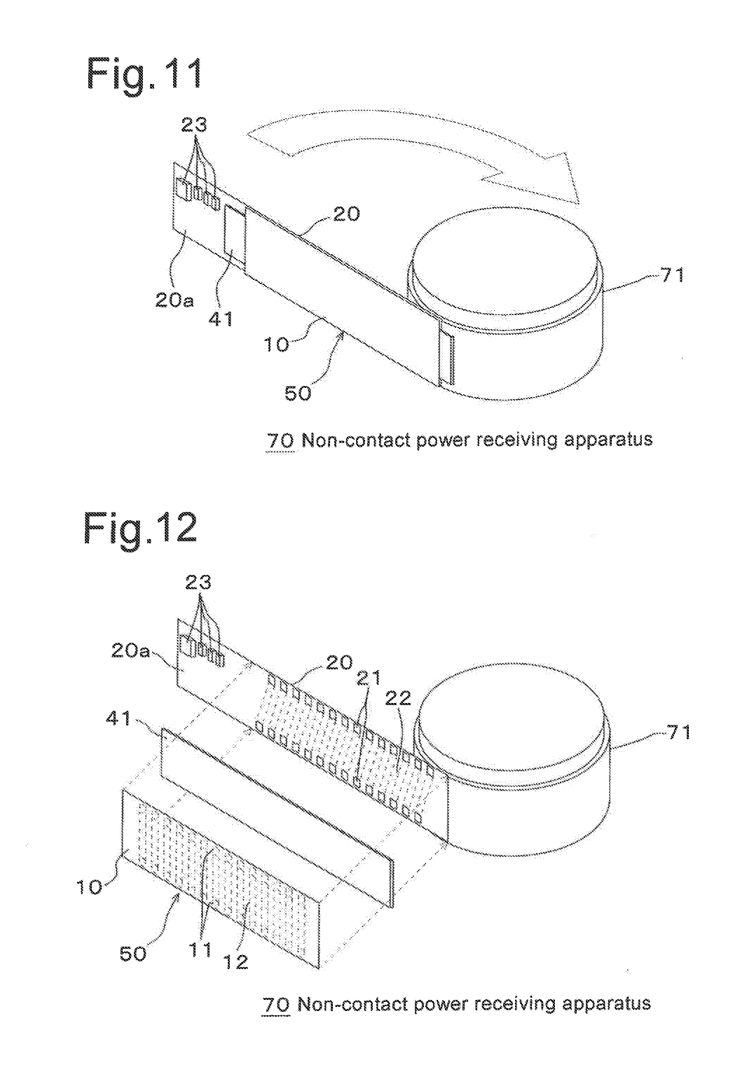

FIG. 10 is a schematic plan view of a non-contact power receiving apparatus 70 according to a fifth embodiment of the present invention. In FIG. 10, the coil 50 is shown as a flat cross section. FIG. 11 is a perspective view of the coil 50 in a developed state of the non-contact power receiving apparatus 70. FIG. 12 is a perspective view of the coil 50 of FIG. 11 in a disassembled state. The non-contact power receiving apparatus 70 has the coil 50 with the same configuration as the third embodiment shown in FIG. 7 wound around a housing side surface (outer circumferential surface) of a rechargeable battery 71 such as a lithium-ion rechargeable battery. The extension portion 20a of the second flexible board 20 of the coil 50 is disposed with a control circuit for non-contact power receiving made up of the electronic components 23 and the conductive pattern not shown. The non-contact power receiving apparatus 70 can receive electric power with the coil 50 from a non-contact power-transmitting coil of a charger not shown so as to charge the rechargeable battery 71. According to this embodiment, the coil 50 for non-contact power receiving is wound (disposed in a bent state) around the housing side surface of the rechargeable battery 71 by using the flexibility thereof and is therefore advantageous for space-saving. Additionally, the coil 50 for the non-contact power receiving can be disposed even when restrictions exist such as inability to ensure a coil disposition space above and under the rechargeable battery 71, and the implementability of the non-contact power receiving function is improved.

### Sixth Embodiment

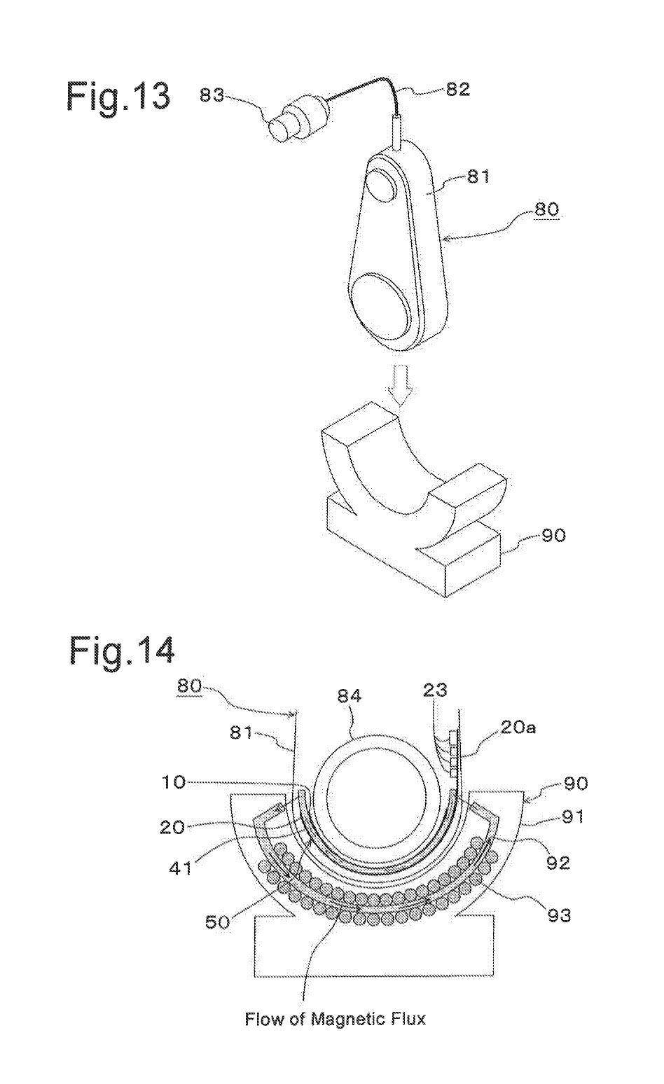

FIG. 13 is a perspective view of a portable electronic device 80 according to a sixth embodiment of the present invention depicted along with a non-contact charger 90. FIG. 14 is a cross-sectional view of a main portion of the portable electronic device 80 placed on the non-contact charger 90. The portable electronic device 80 is a hearing aid in this embodiment and has an insertion portion 83 for the ear at a tip of a cable 82 led out from a housing 81. The housing 81 can be fixed to user's clothes by a locking means such as a clip not shown. The portable electronic device 80 may be of a type hung on the ear or inserted in the ear.

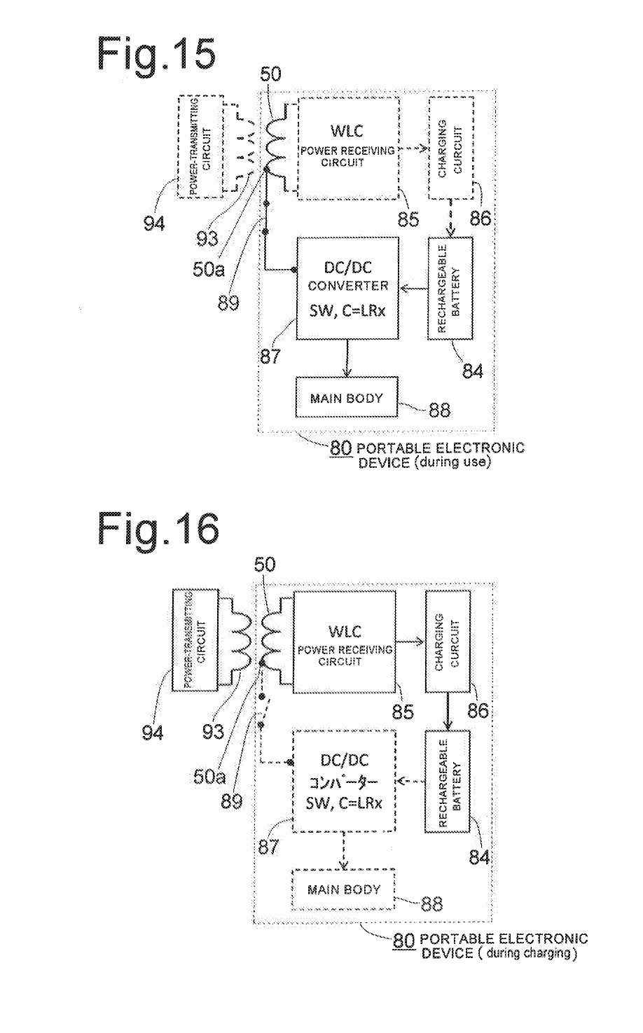

The portable electronic device 80 includes, inside the housing 81, the coil 50 having the same configuration as the third embodiment shown in FIG. 7, a rechargeable battery 84 such as a lithium-ion rechargeable battery, and functional components such as a microphone not shown. Preferably, the coil 50 is a coil unit used for both the non-contact power receiving and the power source, and the extension portion 20a of the second flexible board 20 is disposed with a control circuit for non-contact power receiving (a WLC power-receiving circuit 85 and a charging circuit 86 of FIGS. 15 and 16) and a power source circuit (a DC/DC converter 87 of FIGS. 15 and 16) made up of the electronic components 23 and the conductive pattern not shown. The coil 50 is wound around a housing side surface (outer circumferential surface) of the rechargeable battery 84 (is disposed in a bent state inside the housing 81).

The non-contact charger 90 includes a soft magnetic body 92 and a power-transmitting coil 93 inside the housing 91. A structure of the power-transmitting coil 93 is not particularly limited and has a conductive wire wound around the soft magnetic body 92 in this embodiment. The soft magnetic body 92 has both end portions curved into a circular arc shape and bent toward the center of curvature to come closer to the respective both end portions of the soft magnetic body 41 of the coil 50 of the portable electronic device 80. When a current is applied to the power-transmitting coil 93, a magnetic flux flows as indicated by arrows of FIG. 14 and induces a voltage in the coil 50 on the power-receiving side so that the rechargeable battery 84 can be charged.

FIG. 15 is a circuit diagram of the portable electronic device 80 during use. FIG. 16 is a circuit diagram of the portable electronic device 80 during charging. FIGS. 15 and 16 both show the same circuit, and FIG. 15 shows circuit blocks deactivated during use of the portable electronic device 80 with dashed lines, while FIG. 16 shows circuit blocks deactivated during charging of the portable electronic device 80 with dashed lines. As shown in FIGS. 15 and 16, the coil 50 for power receiving is disposed with a intermediate tap 50a and the intermediate tap 50a is connected through a switch 89 to a DC/DC converter 87. The switch 89 is a switch that can be turned on and off through the electrical control, and is turned on during use of the portable electronic device 80 as shown in FIG. 15 and is turned off during charging of the portable electronic device 80 as shown in FIG. 16. Therefore, the switch 89 is a switch for switching whether the coil 50 is connected to a control circuit of non-contact power receiving or connected to be a part of a power source circuit, between during charging and during use of the portable electronic device 80.

During charging of the portable electronic device 80, a power-transmitting circuit 94 of the non-contact charger 90 drives the power-transmitting coil 93 and a magnetic field generated thereby generates an inductive voltage in the coil 50 for power receiving, so that the inductive voltage causes the WLC (WireLess Charging) power-receiving circuit 85 and the charging circuit 86 to charge the rechargeable battery 84. On the other hand, during use of the portable electronic device 80, the DC/DC converter 87 converts the output voltage of the rechargeable battery 84 into a predetermined voltage for driving a main body 88. The DC/DC converter 87 is a switching power source circuit and uses a coil portion of the coil 50 on one side of the intermediate tap 50a as its own power source coil. This enables the device to deal with the case that inductances necessary for the non-contact power receiving and the power source are different.

As is the case with the fifth embodiment, this embodiment is advantageous for space-saving and the coil 50 for the non-contact power receiving can be disposed even when restrictions exist such as inability to ensure a coil disposition space above and under the rechargeable battery 84, so that the non-contact power receiving function can be implemented in the portable electronic device 80 that has been reduced in size. In this case, since the portable electronic device 80 has the non-contact power receiving function, a space for battery exchange (such as a latch for opening/closing a lid) or a space for inserting a charging cable are no longer necessary and the space made available thereby can be used for disposing the coil 50. Since the control circuit for non-contact power receiving and the power source circuit are disposed on the extension portion 20a of the second flexible board 20 of the coil 50, this embodiment is more excellent in a space-saving property. Additionally, the coil 50 is used for both the non-contact power receiving and the power source and this is advantageous for a reduction in the number of components and the space-saving.

### Seventh Embodiment

In the sixth embodiment described above, a wearable device is exemplified as an embodiment of the portable electronic device to describe the case that the coil 50 is disposed in a bent state in the housing. In this embodiment, a card type device such as an IC card will be described as the portable electronic device. Examples of a card type device equipped itself with a rechargeable battery as a power source are starting to appear in accordance with function improvement. The coil 50 having the same configuration as the sixth embodiment is disposed in a card-shaped housing (e.g., 0.5 to 0.6 mm thick) as a coil for non-contact power receiving. In this case, the coil 50 extends (without being bent) in the housing in parallel with a card surface and, since the coil 50 is flexible, a risk of damage of the coil 50 is small even if the card type device is bent by an external force.

Although the present invention has been described hereinabove referring to the embodiments as examples, it is to be understood by those skilled in the art that the constituent elements and processing processes in the embodiments are variously modified without departing from the scope defined by the appended claims. The modifications will be briefly described below.

In the case exemplified in the first embodiment, the first conductors 12 extend in parallel with the Y direction to electrically connect the first electrodes 11 to each other at X-direction positions equal to each other and the second conductors 22 extend obliquely at a predetermined angle relative to the Y direction to electrically connect the second electrodes 21 to each other at X-direction positions shifted by one electrode from each other. In another embodiment, both the first conductors 12 and the second conductors 22 may extend obliquely at a predetermined angle relative to the Y direction to connect the electrodes to each other at X-direction positions different from each other. The form of extension of the first conductors 12 and the second conductors 22 are not particularly limited as long as the first conductors 12 and the second conductors 22 form a current path helically encircling an axis in the X direction through the first electrodes 11 and the second electrodes 21.

The first conductors 12 and the second conductors 22 may respectively be disposed on the surfaces on the sides opposite to the first electrode 11 and the second electrode 21 of the first flexible board 10 and the second flexible board 20.

In the non-contact power receiving apparatus 70 of the fifth embodiment, the portable electronic device 80 of the sixth embodiment, and the card type device of the seventh embodiment, the coil for power receiving is not limited to the coil 50 of the third embodiment and may be the coil described in the first, second, or fourth embodiment. Although the hearing aid is exemplified as the portable electronic device in the sixth embodiment, the portable electronic device may be a wearable device other than the hearing aid, for example, an earphone, a headset, a wristwatch, a wristband, or eyeglasses, or a portable electronic device other than the wearable type.

1. A coil comprising:
a first flexible board having a plurality of first electrodes and a plurality of first conductors; and
a second flexible board having a plurality of second electrodes and a plurality of second conductors, wherein
the first and second flexible boards are combined with each other such that the first and second electrodes are in face-to-face contact with each other, and
the first and second conductors form a current path helically encircling an axis extending in a direction substantially parallel to surfaces of the first and second flexible boards and through the first and second electrodes.

2. The coil according to claim 1, wherein
the first electrodes are disposed such that respective pluralities of the first electrodes are separately located on first and second sides, which are opposite each other, of the first flexible board,
each of the first conductors electrically connects one of the first electrodes on the first side of the first flexible board and one of the first electrodes on the second side of the first flexible board to each other,
the second electrodes are disposed such that respective pluralities of the second electrodes are separately located on first and second sides, which are opposite each other, of the second flexible board, and
each of the second conductors electrically connects one of the second electrodes on the first side of the second flexible board and one of the second electrodes on the second side of the second flexible board to each other.

3. The coil according to claim 1, comprising a soft magnetic body located between the first and second conductors.

4. The coil according to claim 3, wherein the soft magnetic body is longer than axial length of the helically encircling current path.

5. The coil according to claim 1, wherein
the second flexible board has an extension portion extending on an outer side of the first flexible board, and
the extension portion includes a circuit.

6. The coil according to claim 1, wherein the coil is flexible.

7. The coil according to claim 1, including a housing, wherein the coil is bent and disposed inside the housing.

8. A coil comprising:
a flexible board having pluralities of electrodes respectively disposed proximate first and second sides, which are opposite each other, and a plurality of conductors respectively electrically connecting the electrodes on the first side to the electrodes on the second side, wherein
the flexible board is bent so that the electrodes on the first side and the electrodes on the second side are in face-to-face contact with each other, and
the conductors form a current path helically encircling an axis extending in a direction substantially parallel to a surface of the flexible board.

9. A non-contact power receiving apparatus comprising:
a coil for non-contact power reception and a housing, wherein the coil is disposed in the housing, is a flexible coil and includes
a first flexible board having a plurality of first electrodes and a plurality of first conductors, and
a second flexible board having a plurality of second electrodes and a plurality of second conductors, wherein
the first and second flexible boards are combined with each other such that the first and second electrodes are in face-to-face contact with each other, and
the first and second conductors form a current path helically encircling an axis extending in a direction substantially parallel to surfaces of the first and second flexible boards and through the first and second electrodes.

10. The non-contact power receiving apparatus according to claim 9, wherein the coil is bent inside the housing.

11. The non-contact power receiving apparatus according to claim 9, wherein
the second flexible board has an extension portion extending on an outer side of the first flexible board, and
the extension portion includes a control circuit for non-contact power reception.

12. A portable electronic device comprising:
a rechargeable battery, a housing, and a coil for non-contact power reception, wherein the coil is disposed in the housing and is a flexible coil and includes
a first flexible board having a plurality of first electrodes and a plurality of first conductors, and
a second flexible board having a plurality of second electrodes and a plurality of second conductors, wherein
the first and second flexible boards are combined with each other such that the first and second electrodes are in face-to-face contact with each other, and
the first and second conductors form a current path helically encircling an axis extending in a direction substantially parallel to surfaces of the first and second flexible boards and through the first and second electrodes.

13. The portable electronic device according to claim 12, wherein the coil is bent inside the housing.

14. The portable electronic device according to claim 12, wherein
the second flexible board has an extension portion extending on an outer side of the first flexible board, and
the extension portion includes at least a part of a power source circuit that is fed an output voltage of the rechargeable battery.

15. The portable electronic device according to claim 14, wherein the coil is part of the power source circuit.

16. The portable electronic device according to claim 15, wherein the portable electronic device switches to determine whether the coil is connected to a control circuit for non-contact power reception or connected to be a part of the power source circuit, between charging and use of the portable electronic device.

17. The portable electronic device according to claim 15, wherein the coil includes an intermediate tap, and a coil portion on one side of the intermediate tap is part of the power source circuit.
